(19) United States
(12) Patent Application Publication
(10) Pub. No.: US 2005/0155301 A1
(43) Pub. Date: Jul. 21, 2005

(54) Impact resistant window assembly

(76) Inventors: Jerome A. Hapka, Warroad, MN (US); Lenny Wong, Warroad, MN (US); Daniel J. Curtis, Warroad, MN (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/758,967

(22) Filed: Jan. 16, 2004

(51) Int. Cl. E06B 1/04

(52) U.S. Cl. 52/210

(57) ABSTRACT

An impact resistant window assembly includes a bracket assembly that has a bracket portion with a first position and a second position. The bracket assembly is disposed within the window jamb assembly when the bracket portion is disposed in the first position, and the bracket portion disposed over a portion of the interior portion of the sash when the bracket portion is disposed in the second position.

### TECHNICAL FIELD

The present disclosure relates to impact resistant windows and doors, and more particularly relates to window and door assemblies having impact resistant features.

### TECHNICAL BACKGROUND

Exterior windows, such as sliding glass windows and doors are typically mounted in building walls to provide a view to the exterior of the building. The windows also provide a barrier against weather including wind and rain.

Severe weather conditions and high winds, which can occur in hurricanes or tornadoes, or in strong thunderstorms, subject the exterior window to high pressure, risking dislodgement of the window, or a portion of the window from the outer frame. Furthermore, during severe weather conditions, flying debris can be hurled at the window also risking dislodgement or damage.

In order to protect windows during extreme weather, some homeowners secure larger objects such as plywood over the windows. While effective, this approach requires a substantial amount of work to install and uninstall, expensive materials, and is unsightly. Furthermore, securing the plywood to the house results in forming holes in the exterior portion of the building. These holes are later patched and are also unsightly. Another approach to securing the window is to provide a rotatable lock on the sash. However, this provides an unattractive appearance to the window, and may not be effective.

Accordingly, what is needed is a window assembly with impact resistant features that facilitate providing a pleasing appearance for the window.

### SUMMARY

An impact resistant window assembly includes a double hung window including a window sash movably disposed within a window jamb assembly, where the window sash has an exterior portion and an interior portion. The window assembly further includes a bracket assembly including a bracket portion having at least a first position and a second position. The bracket assembly is disposed within the window jamb assembly when the bracket portion is disposed in the first position, and the bracket portion disposed over a portion of the interior portion of the sash when the bracket portion is disposed in the second position.

Several options for the window assembly are as follows. In one option, the bracket portion is slidable from the first position to the second position. In another option, the bracket portion includes a stop, where the stop prevents overextension of the bracket portion. The bracket portion, in one option, is disposed over a portion of the rail and the stile when the bracket portion is disposed in the second position. The bracket assembly further includes, in one option, a filler disposed within the window jamb assembly.

A method is provided including coupling a bracket assembly with a window jamb of a window unit, movably disposing a window sash within the window jamb. The method further includes moving a bracket portion of the bracket assembly from a first position within the window jamb to a second position over the window sash, and reinforcing the window sash with the bracket assembly when the bracket portion is disposed in the second position.

Several options for the method are as follows. For example, in one option, moving the bracket portion to the second position includes moving the bracket portion over a stile and rail of the window sash. Other options include disposing the bracket portion in the first position in a recess of the jamb liner, and substantially concealing the bracket assembly from a front view of the window unit. The method includes, in one option, disposing a filler component adjacent to the bracket portion of the bracket assembly.

The storm bracket assembly provides enhanced protection for a window or door, without detracting from the appearance of the window or door unit. For example, the storm bracket assembly allows the window or door to withstand greater wind gusts or impact from debris without becoming displaced from the outer window or door frame, and yet the storm bracket assembly can be concealed within an outer portion of the window unit when not in use. Furthermore, the storm bracket assembly does not add to installation costs of the window or door. The storm bracket assembly can be pre-installed during the manufacturing of the window assembly, thereby reducing installation time, while raising an otherwise standard double hung window assembly to the level of an impact resistant double hung window assembly.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### BRIEF DESCRIPTION OF THE DRAWINGS

FIG. 1 is a front elevational view illustrating a window assembly constructed in accordance with one embodiment.

FIG. 2A is a perspective view of a storm bracket assembly and a portion of the window assembly constructed in accordance with one embodiment.

FIG. 2B is an exploded perspective view of a storm bracket assembly and a portion of the window assembly constructed in accordance with one embodiment.

FIG. 3 is a front elevational view of a portion of the storm bracket assembly and a portion of the window assembly constructed in accordance with one embodiment.

FIG. 4A is a top view of a movable bracket portion constructed in accordance with one embodiment.

FIG. 4B is a front view of the movable bracket portion constructed in accordance with one embodiment.

FIG. 4C is a side view of the movable bracket portion constructed in accordance with one embodiment.

FIG. 5A is a perspective view of a support bracket constructed in accordance with one embodiment.

FIG. 5B is a front view of the support bracket constructed in accordance with one embodiment.

FIG. 5C is a side view of the support bracket constructed in accordance with one embodiment.

FIG. 6A is a top view of a filler constructed in accordance with one embodiment.

FIG. 6B is a bottom of the filler constructed in accordance with one embodiment.

FIG. 6C is a front view of the filler constructed in accordance with one embodiment.

FIG. 6D is a cross-sectional view of the filler taken along 6D-6D of FIG. 6C.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope is defined by the appended claims and their equivalents.

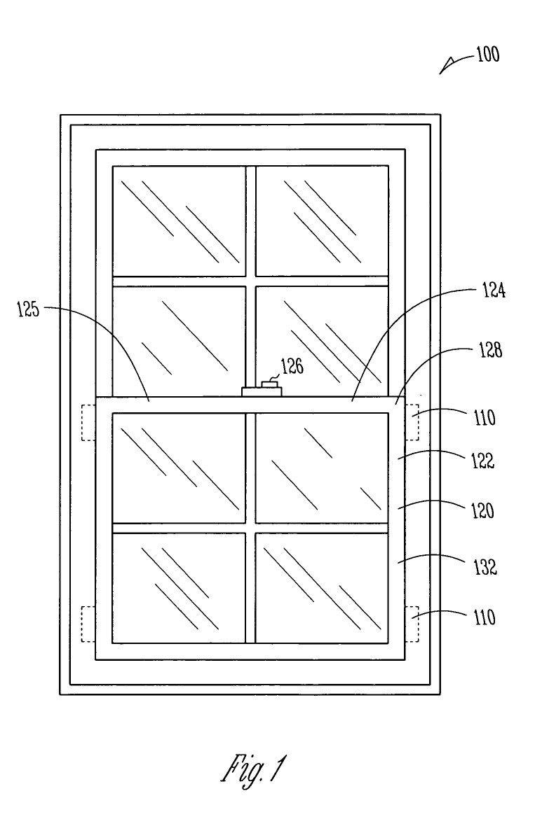

FIG. 1 illustrates a window assembly 100 with impact resistant features, and includes at least one storm bracket assembly 110. Although the discussion herein relates to a window assembly 100, it should be noted that the storm bracket assembly 110 can be incorporated with other units such as, but not limited to, sliding glass doors, casement windows, exterior doors, etc., without departing from the scope of the application. The storm bracket assembly 110 assists in preventing a sash 120, such as a lower sash of a double hung window, from getting pushed into the interior of a building. In one option, the window assembly 100 includes multiple storm bracket assemblies 110, for example at each of the corner portions of the sash 120, as further discussed below.

The window assembly 100, in one option, includes an upper sash and a lower sash, where the lower sash is typically raised and lowered relative to the upper sash. The window sash 120 is defined in part by an interior portion 132 and an exterior portion, and is further defined by a sash corner 128. The window sash 120 includes vertical stiles 122 and horizontal members 124, including a checkrail 125.

The window sash 120 includes, in one option, a locking feature and/or an actuator 126. The locking features allow for the window sash to be locked to, for example, the other sash of the double hung unit. The optional actuator, for example, is an actuator as described in U.S. Pat. No. 6,588,150, entitled “ROTATABLE ACTUATOR FOR LATCHES OF A WINDOW SASH”, which is incorporated herein by reference. The locking feature is provided in addition to the storm bracket assembly. The locking features 126 are meant to be used from day-to-day, where the storm bracket assembly 110 is typically used in advance of an event, such as extreme weather.

The window sash 120 further includes latches therein that allow for the window sash 120 to be slid within the window jamb. The latches guide the sash within the window jamb, and are retractable within the sash, allowing for the sash to be removed or tilted away from the window jamb. One example of latches is described in U.S. Pat. No. 6,141,913, entitled “WINDOW SASH POSITION MAINTAINER”, which is incorporated herein by reference.

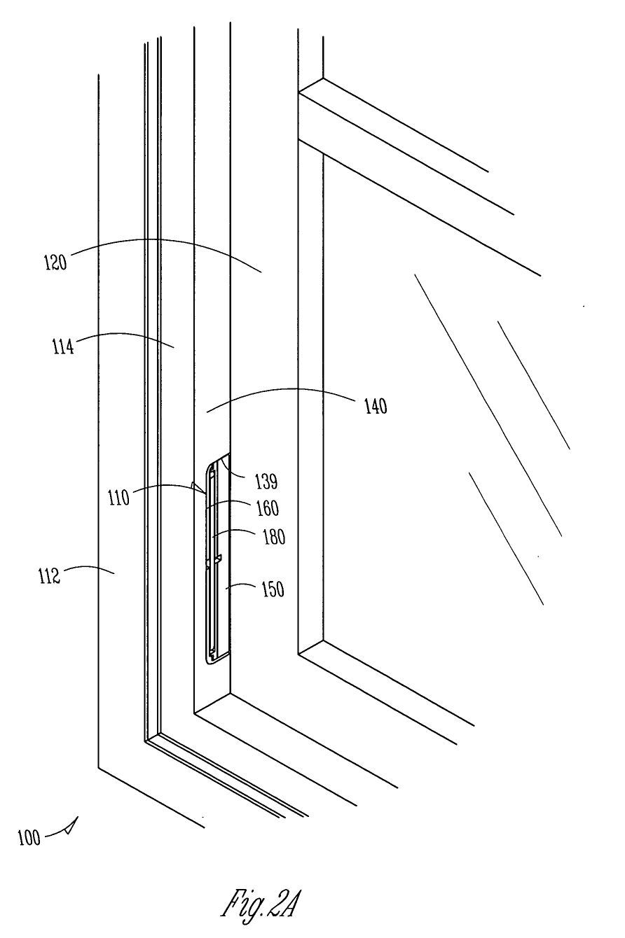

Referring to FIGS. 2A and 2B, the window assembly 100 includes an outer frame 112 to which a window jamb assembly 114 is typically installed. The window jamb assembly 114 further includes, in one option, a jamb liner 140. The jamb liner 140 sits adjacent to the window sash 120, where the window sash 120 moves relative to the jamb liner 140. The storm bracket assembly 110 is disposed within an opening 139 of the jamb liner 140, and allows for the storm bracket assembly 110 to be substantially concealed therein as further discussed below. The storm bracket assembly 110 is concealed in the jamb liner 140, eliminating the need to stain, paint, or treat the storm bracket assembly 110 and while not detracting from the beauty and appearance of the window.

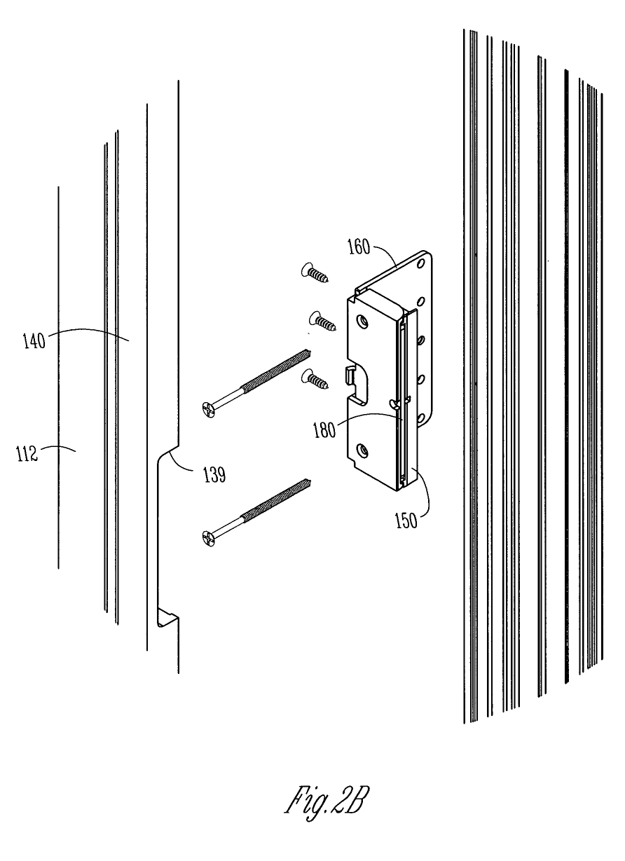

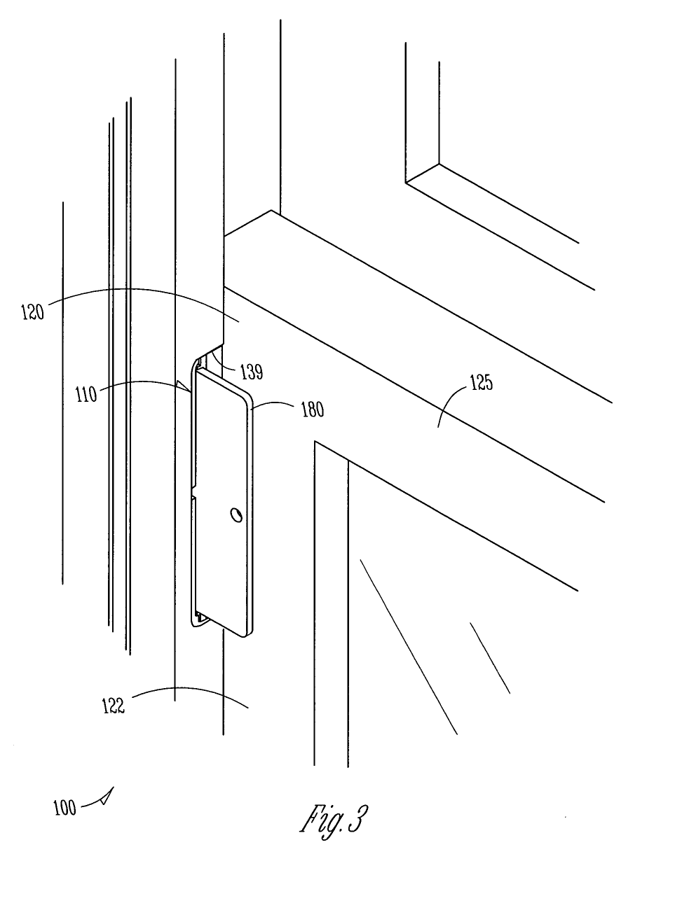

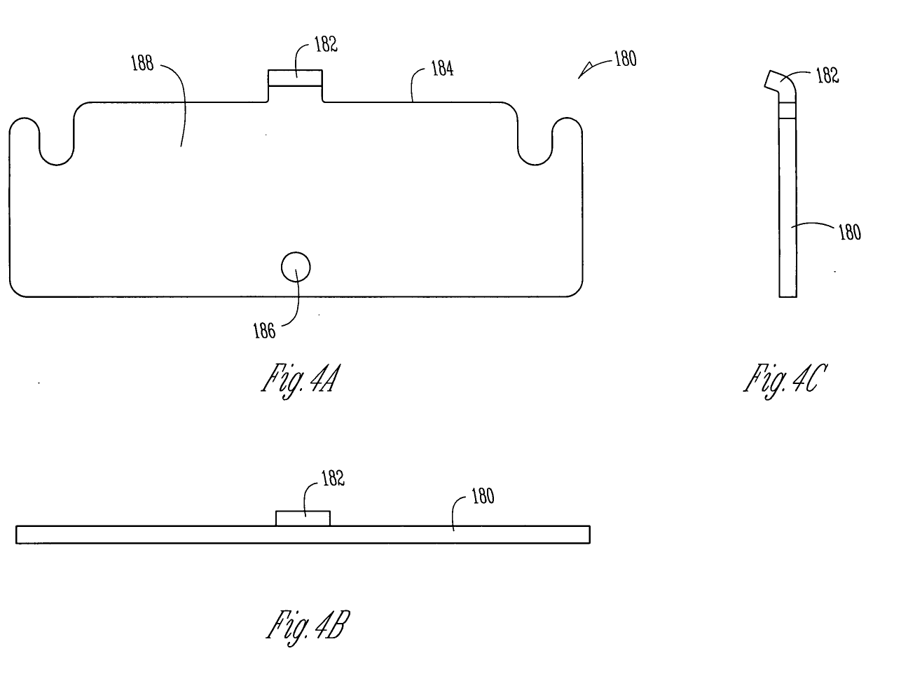

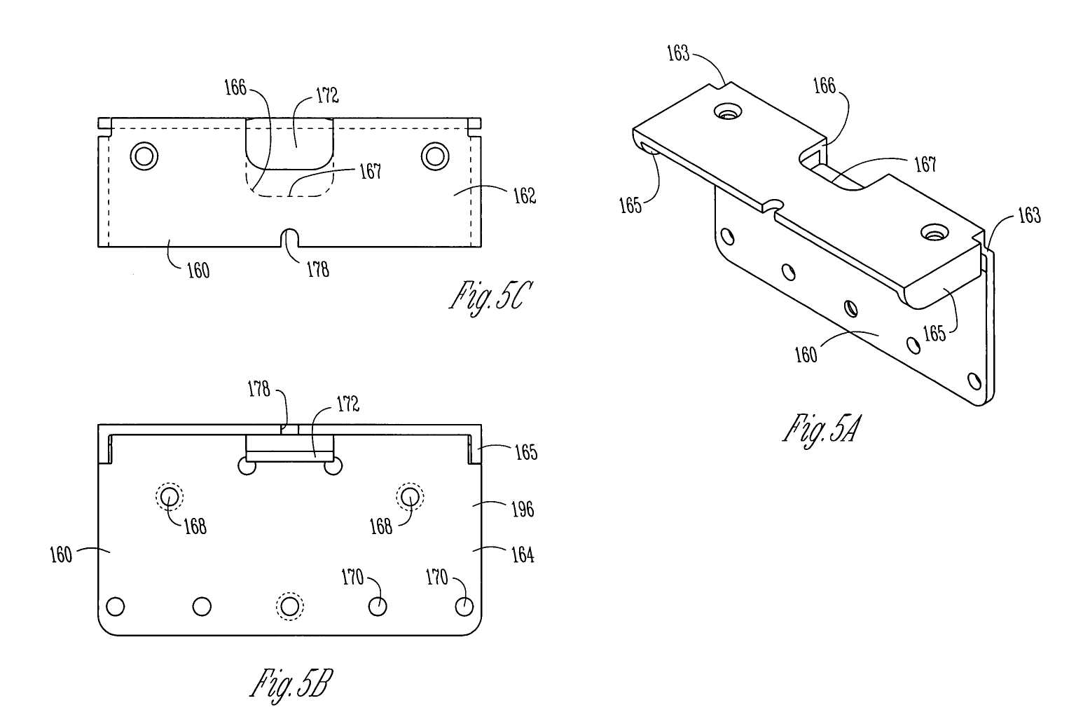

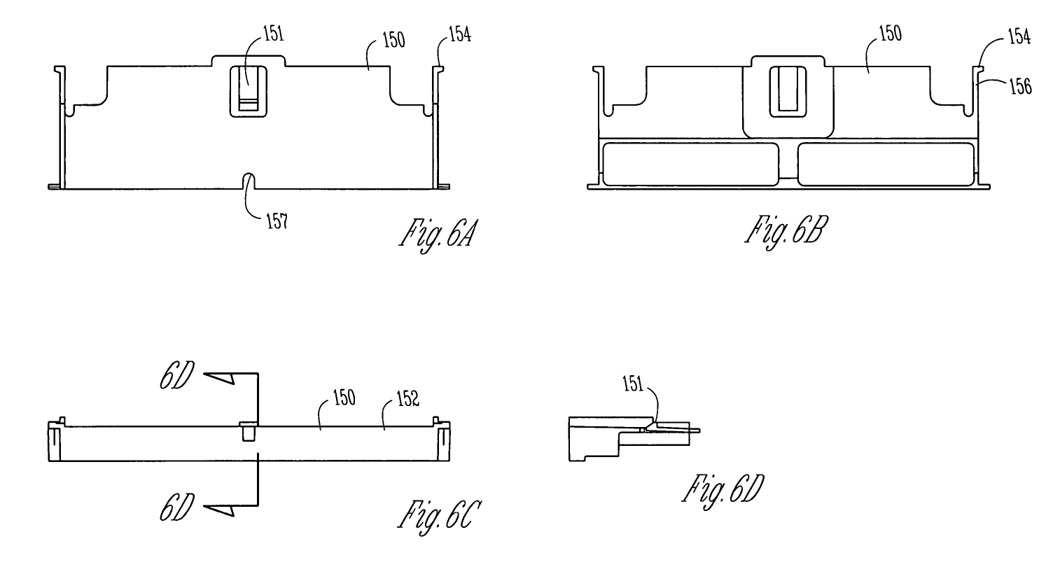

The storm bracket assembly 110 includes a base plate 160 (FIGS. 5A-5C), a movable bracket portion 180 (FIGS. 4A-4C), and optionally a filler 150 (FIG. 6A-6D). The movable bracket portion 180 of the storm bracket assembly 110 can be disposed in a first position and a second position, where in the first the position each component of the bracket assembly 110 is at least substantially disposed within a side portion of the window, such as the window jamb assembly, as shown in FIG. 2A.

In one option, the bracket assembly 110 is substantially concealed from a frontal view of the window unit when the movable bracket portion 180 is disposed in the first position. In the second position, as illustrated in FIG. 3, a portion of the bracket assembly 110, for example a movable bracket portion 180, is disposed over a portion of the interior portion of the window sash 120, and assists in retaining the sash 120 within the window jamb assembly. In one option, the movable bracket portion 180 is disposed over a portion of the vertical stile 122 in the second position. In another option, the movable bracket portion 180 is disposed over a portion of the checkrail 125 in the second position. In yet another option, the movable bracket portion 180, in the second position, is disposed over a portion of both the vertical stile 122 and the checkrail 125.

Referring to FIGS. 5A-5C, the base plate 160 is illustrated in greater detail. The base plate 160 secures the bracket assembly 110 (FIG. 2) to the frame of the window, and provides support to the bracket portion 180 (FIG. 3) if force is applied to the sash 120 (FIG. 3). The base plate 160 is formed of metal, for example, by stamping. Other materials such as, but not limited to, high strength plastics can also be used for the base plate. The base plate 160 generally has an L-shape including a side plate 162 and a back plate 164. The base plate 160 further includes a cut out 166 that extends into both the side plate 162 and the back plate 164. The cut out 166 works with the movable bracket portion, as further described below. In one option, the cut out 166 forms a curved cut out in which a portion of the movable bracket portion can be guided as it is moved between the first position and the second position, and vice versa. In another option, the cut out is multi-directional, allowing for the same base plate to be used in multiple corners of the window assembly. The base plate 160 allows for the assembly 110 to be anchored to the frame, adding to the protection provided to the sash when the movable plate is in the extended position.

The back plate 164 includes one or more apertures 168 that allow for the bracket assembly to be mounted to the sides of the jamb with, for example, ⅝″ screws. The back plate 164 can be mounted at the factory, saving installation time at the job site. In one option, the back plate 164 is designed to be used in the various four-corners of the sash without requiring multiple designs. For example, the same component can be used in the upper left corner of the sash, or the upper right corner of the sash. The back plate 164 further includes framing stud apertures 170. Screws such as 3″ screws are secured through the framing stud apertures 170 to anchor the window frame to the building structure. When installed, the base plate 160, and the bracket assembly 110, have fasteners that fasten the bracket assembly 110 to the outer frame that are not visible, and therefore do not detract from the appearance of the window.

The back plate 164 meets the side plate 162 at approximately a 90 degree angle. As mentioned above, the side plate 162 includes the cut out 166 therein. In forming the cut out 166, a flap 172 is also formed. The flap 172 assists in preventing the components from interfering with other components within the window, such as the balance tube assembly. The cut out 166 is further defined by edge 167, which catches a portion of the movable bracket portion 180 (FIG. 4A), and assists in prevention of overextension of the movable bracket portion 180 (FIG. 4A). The side plate 162 further includes one or more side cut outs 163 that interact with interlocking features of the filler.

The side plate 162, in one option, further includes flanges 165 that add to the inertia of the profile of the device. The flanges 165 further assist in containing the movable bracket portion 180 (FIG. 3) and the filler 150 from movement in the vertical direction. The side plate 162 further includes an access cut out 178 that allows a user to access the movable bracket portion 180 (FIG. 2) during use of the device.

Referring to FIGS. 4A-4C, the movable bracket portion 180 is a movable component that moves between the first position as shown in FIG. 2 to a second position as shown in FIG. 3. In the second position, the movable bracket portion 180 covers a portion of the sash 120 (FIG. 3), and prevents inadvertent dislodgement of the sash 120. The movable bracket portion 180 further includes a tool access port 186 in which a tool, such as an unfolded paperclip, can be disposed. The tool couples with the movable bracket portion 180 at the tool access port 186, and the user can move the movable bracket portion 180 to the second position. It should be noted that other tool interfaces are contemplated such as projections, interference fit. Other designs may include features on the movable bracket portion 180, allowing the movable bracket portion 180 to be manually or automatically manipulated. For example, a remote actuator can be coupled directly or indirectly with the movable bracket portion 180.

The movable bracket portion 180 is movable relative to the window jamb liner. It should be noted that the movable bracket portion 180 can be moved in several manners. For example, in one option, the movable bracket portion 180 is slidable from the first position to the second position. In another option, the movable bracket portion 180 is rotatable from the first position to the second position. In yet another option, the movable bracket portion 180 has a hinge about which the movable bracket portion 180 moves.

The movable bracket portion 180 is formed of a stamped metal component, although other materials and forming methods can also be achieved. The movable bracket portion 180 generally has a rectangular shape, but is not necessarily so limited to such a shape. Other shapes for the movable bracket portion 180 can be incorporated as well. When extended to the second position, a planar portion 188 of the movable bracket portion 180 covers, in one option, approximately an area of 4 inches by 0.5 inches over the edge of the sash to distribute impacts forces over an area of support.

The movable bracket portion 180, in one option, further includes a stop 182 that assists in preventing over-extension of the movable bracket portion 180. The stop 182 forms a part that engages a portion of the base plate 160 (FIG. 5C), such as edge 167 (FIG. 5C) of the support bracket cut out 166 (FIG. 5C). The stop 182, in one option, is a flange extending from the planar portion 188, for example, with a curved or hook shape. When the movable bracket portion 180 is moved back to the first position, the edge 184 of the movable bracket portion 180, in another option, stops movement of the movable bracket portion 180 when it abuts the wall 196 (FIG. 5B) of the base plate 160.

The bracket assembly 110 further includes, in one option, a filler 150 disposed therein, illustrated in greater detail in FIGS. 6A-6D. The filler 150 assists in providing a tighter clearance fit for the movable bracket portion 180, and further assists in interlocking the bracket assembly 110 together. The filler 150, in another option, assists in concealing or substantially concealing the bracket assembly 110 within the window jamb assembly, as the filler 150 can be given an appearance that is similar to surrounding or nearby components, such as, but not limited to, the color of wood or painted wood. For example, the a lower sash of the window unit is disposed in a lowered position (see FIG. 1), and the movable bracket portion 180 is disposed in the first position, only the edge or minor surfaces of the movable bracket portion 180 and the base plate 160 are viewable (see FIG. 2).

The filler 150, in one option, is formed of plastic such as a molded plastic. It should be noted that the filler 150 can be formed of other materials that are shock absorbent. The filler 150 can further be provided with an outer surface 152 (FIG. 6C) that is treatable or paintable, allowing for the filler 150 to better blend with surrounding components, such as the liner. The outer surface 152, in one option, is further provided with an opening 157 that allows access for a tool or finger to the movable bracket portion, and allowing access to move the movable bracket portion into the second position.

The filler 150 includes one or more optional interlocking features 154. The interlocking features 154 assist in interlocking the movable bracket portion 180 with the base plate 160. The interlocking features, in one option, include opposing cantilever members which are sized to be received by the side cut outs 163 (FIG. 5A). The opposing cantilever members are disposed on opposing sides of the filler 150. In one option, the interlocking feature 154 includes a central flange 151, that is suitable for interlocking with the cut out 166 (FIG. 5C). In another option, the central flange 151 assists in preventing the movable bracket portion 180 (FIG. 4A) from prematurely or inadvertently sliding back into the jamb liner. The interlocking features 154 assist in interlocking the filler 150 with the support bracket 160 (FIG. 5A) and the movable bracket portion 180 (FIG. 4A).

A method is further provided herein. The method includes providing a storm bracket assembly with a window assembly. The support bracket is coupled with a portion of the outer frame, for example, at the factory. The window sash is movably disposed within the window jamb. The bracket assembly includes a movable bracket portion. During use of the device, a user moves the bracket portion of the bracket assembly from a first position within the window jamb to a second position over the window sash, and reinforcing the window sash with the bracket assembly when the bracket portion is disposed in the second position.

In one option, moving the bracket portion to the second position includes moving the bracket portion over a stile and rail of the window sash. Other options include disposing the bracket portion in the first position in a recess of the jamb liner, and substantially concealing the bracket assembly from a front view of the window unit. The method includes, in one option, disposing a filler component adjacent to the bracket portion of the bracket assembly, and optionally concealing the bracket portion with the filler.

Advantageously, the storm bracket assembly provides enhanced protection for a window or door, without detracting from the appearance of the window or door unit. For example, the storm bracket assembly allows the window or door to withstand greater wind gusts or impact from debris without becoming displaced from the outer window or door frame, or provides security from intruders, and yet the storm bracket assembly can be concealed within an outer portion of the window unit when not in use. It should be noted that when not in use, the bracket assembly does not interfere with the tilting functions of the window assembly. Furthermore, the fasteners for the storm bracket assembly are concealed from view and do not detract from the appearance of the window.

Furthermore, the storm bracket assembly does not add to installation costs of the window or door. The storm bracket assembly can be pre-installed during the manufacturing of the window assembly, thereby reducing installation time, while raising an otherwise standard double hung window assembly to the level of an impact resistant double hung window assembly.

It is to be understood that the above description is intended to be illustrative, and not restrictive. Many other embodiments will be apparent to those of skill in the art upon reading and understanding the above description. It should be noted that embodiments discussed in different portions of the description or referred to in different drawings can be combined to form additional embodiments of the present application. The scope of the invention should, therefore, be determined with reference to the appended claims, along with the full scope of equivalents to which such claims are entitled.

1. An impact resistant window assembly comprising:
a double hung window including a window sash movably disposed within a window jamb assembly, the window sash having an exterior portion and an interior portion; and
a bracket assembly including a bracket portion having at least a first position and a second position, the bracket assembly disposed within the window jamb assembly when the bracket portion is disposed in the first position, the bracket portion disposed over a portion of the interior portion of the sash when the bracket portion is disposed in the second position.

2. The impact resistant window assembly as recited in claim 1, wherein the bracket portion is slidable from the first position to the second position.

3. The impact resistant window assembly as recited in claim 1, wherein the bracket assembly is substantially concealed in the window jamb assembly when the bracket portion is disposed in the first position.

4. The impact resistant window assembly as recited in claim 1, wherein the bracket portion includes a stop, where the stop prevents overextension of the bracket portion.

5. The impact resistant window assembly as recited in claim 1, wherein the window sash includes a rail and a stile, and the bracket portion is disposed over a portion of the rail and the stile when the bracket portion is disposed in the second position.

6. The impact resistant window assembly as recited in claim 1, wherein the bracket assembly further includes a filler disposed within the window jamb assembly.

7. The impact resistant window assembly as recited in claim 1, further comprising one or more fasteners securing the bracket assembly to an outer frame, where the one or more fasteners are concealed from view.

8. An impact resistant window assembly comprising:
a window including a window sash movably disposed within a window jamb assembly, the window further including a window jamb liner, the window sash having an exterior portion and an interior portion, the window sash slidable within a first plane of movement;
a bracket assembly disposed within the window jamb liner, the bracket assembly including a filler and a movable bracket portion, the movable bracket portion having at least a first position and a second position, the bracket assembly providing reinforcement to the interior portion of the sash when the bracket portion is disposed in the second position, and the bracket assembly is at least partially concealed in the first position.

9. The impact resistant window assembly as recited in claim 8, wherein the bracket assembly further includes a base plate coupled with an outer frame of the window.

10. The impact resistant window assembly as recited in claim 9, wherein the movable bracket portion is disposed between the filler and the support bracket.

11. The impact resistant window assembly as recited in claim 9, wherein the filler includes interlock features, the interlock features coupling the support plate and the movable bracket portion.

12. The impact resistant window assembly as recited in claim 8, wherein the window sash includes a rail and a stile, and the bracket portion is disposed over a portion of the rail and the stile when the bracket portion is disposed in the second position.

13. The impact resistant window assembly as recited in claim 8, wherein the filler has an outer appearance similar to the jamb liner.

14. A method comprising:
coupling a bracket assembly with a window jamb of a window unit;
movably disposing a window sash within the window jamb;
moving a bracket portion of the bracket assembly from a first position within the window jamb to a second position over the window sash; and
reinforcing the window sash with the bracket assembly when the bracket portion is disposed in the second position.

15. The method as recited in claim 14, wherein moving the bracket portion to the second position includes moving the bracket portion over a stile and rail of the window sash.

16. The method as recited in claim 14, wherein coupling a bracket assembly with a window jamb includes disposing the bracket assembly within an opening of a jamb liner.

17. The method as recited in claim 16, further comprising disposing the bracket portion in the first position in the opening of the jamb liner, and substantially concealing the bracket assembly from a front view of the window unit.

18. The method as recited in claim 14, further comprising disposing a filler component adjacent to the bracket portion of the bracket assembly.

19. The method as recited in claim 14, wherein the bracket assembly further includes a filler and support bracket, and further comprising interlocking the support bracket and the movable bracket with the filler.

20. The method as recited in claim 14, wherein moving the bracket portion of the bracket assembly includes sliding the bracket portion from the first position to the second position.

21. The method as recited in claim 14, further comprising overextension of the bracket portion from the window jamb.

22. The method as recited in claim 14, further comprising anchoring the bracket assembly with a window frame.
